(19) United States
(12) Patent Application Publication
(10) Pub. No.: US 2025/0075564 A1
(43) Pub. Date: Mar. 6, 2025

(54) BEND RESISTOR

(71) Applicant: PHOENIX ENGINEERING SYSTEMS LIMITED, Yorkshire (GB)

(72) Inventor: Donald Innes WALLACE, Yorkshire (GB)

(21) Appl. No.: 18/712,937

(22) PCT Filed: Dec. 12, 2022
(86) PCT No.: PCT/GB2022/053170

§ 371 Date: May 23, 2024

(30) Foreign Application Priority Data
Dec. 14, 2021 (GB) 2118097.1

(51) Int. Cl. E21B 17/01

(52) U.S. Cl. CPC E21B 17/017

(57) ABSTRACT

The present application provides apparatus (200) for resisting bending of an elongate and flexible member, comprising an elongate inner support structure (202) defining an axial bore (254) for receiving an elongate and flexible member subject to bending in use, and at least one outer layer (204) comprising a plurality of fibres embedded in a polymer matrix, wherein each fibre is helically arranged along the outer layer and configured to resist a tensile force during said bending in use. A method of manufacturing the apparatus is also provided.

The present invention relates to apparatus for resisting bending of an elongate member, such as a pipe, hose or electrical cable.

Elongate and flexible members, such as subsea cables and hoses, are often subject to load conditions that could lead to excessive bending resulting in failure of the cable or hose by, for example, deformation, rupture, buckling, fatigue or fracture. It is therefore known to fit or integrate a device to the cable or hose to restrict or limit bending at a particular bend location. Typically, this kind of protection would be required at an interface between the flexible member and a relatively stiff structure, such as a coupling or a bulkhead. Such a device is also typically employed where something is attached to the flexible member, such as a lifting device, or at a transverse intersection between two flexible members.

Conventional bend limiters (also known as bend restrictors) are typically configured to limit the bending action of a flexible member by mechanical locking of segments arranged around the flexible member. The bend limiter includes segments that are made in substantially symmetrical halves and bolted together around the flexible member. The segments are designed such that one end forms a dumbbell shape and the other end forms a cavity. The segments are bolted together in such a way that the dumbbell end of each segment is loosely trapped inside the cavity of the adjacent segment. When one segment is articulated at an angle relative to another segment, the movement is limited by the dumbbell end contacting the inner walls of the cavity at upper and lower contact points. The angle of articulation is mainly determined by the difference in the thickness of the dumbbell end compared to the width of the cavity. The total angle of articulation of the assembly is determined by the number of segments in the assembly.

Tension in the flexible member generates a bending moment in the bend limiter assembly which is highest at the intersection of the bend limiter assembly and the relatively stiff structure, such as a coupling or a bulkhead. This bending moment manifests itself as stress in the segment.

The overall diameter of a bend limiter assembly is driven by the diameter of the flexible member and the maximum bending moment generated in the assembly. The diameter of the flexible member determines the internal diameter of the segment. The wall thickness of the segment will be designed to be sufficient to limit the stresses generated by bending and contact to a level below an allowable stress determined by the material properties. For example, the flexible member may be polyurethane and have a diameter of around 76 mm and the resulting outer diameter of the segment may be 266 mm, which is a ratio of over 3.5. This could be regarded as typical, although some assemblies will be designed based on a much larger ratio.

Generally, a bend limiter will offer practically no resistance to bending until the bend radius reduces to a predetermined limit, at which point internal clearances between adjacent segments of the bend limiter assembly will close and the assembly will lock at that radius. As the bending load increases, the assembly will maintain substantially the same radius until the mechanical limit of the material is reached, at which point the assembly will fail.

Another known type of device to restrict bending is referred to as a ‘bend stiffener’ which is a device comprising a sleeve of material which is fitted around the flexible member. The device is usually tapered from a wide end region which is typically fixed to a relatively stiff structure, such as a coupling or a bulkhead, to a narrow end region. Bend stiffeners are also often made in substantially symmetrical halves that are bolted together over the flexible member to form the tapered sleeve therearound.

This type of device relies on the increased sectional diameter of the assembly and the material modulus thereof to provide a resistance to bending. When loaded, the device will offer resistance to bending progressively as the load is applied and the bend radius reduces with no hard limit. The tapered profile of the device controls the distribution of the bend such that it is minimised at the transition from the flexible member to the relatively stiff member and distributed over its length. The maximum bending moment and minimum radius are determined by the geometry and the strength of the material chosen for the bend stiffener and the device will continue to bend until mechanical failure occurs. However, the stiffness of the device is mainly driven by its diameter and a cable, for example, under tension would require a bend stiffener providing a relatively high stiffness and this could drive the diameter to such a size as to render the design impracticable and unviable.

It is an aim of certain embodiments of the present invention to provide apparatus for resisting bending of an elongate member, such as a pipe, hose or electrical cable, and thereby restrict or limit the amount of bending to prevent failure.

It is an aim of certain embodiments of the present invention to provide apparatus for resisting bending of an elongate member, such as a pipe, hose or electrical cable, particularly in a marine or subsea environment, wherein the bending load is substantially evenly distributed through the apparatus and the bending radius is substantially maintained over the length of the apparatus.

It is an aim of certain embodiments of the present invention to provide apparatus for resisting bending of an elongate member, such as a marine or subsea pipe or cable, wherein the apparatus provides a higher bending stiffness than a similarly-sized conventional bend stiffener.

It is an aim of certain embodiments of the present invention to provide apparatus for resisting bending of an elongate member, such as a marine or subsea pipe or cable, wherein the apparatus is particularly robust to withstand the most aggressive environments and protect against crushing or penetration by external bodies.

It is an aim of certain embodiments of the present invention to provide apparatus for resisting bending of an elongate member, such as a marine or subsea pipe or cable, wherein the apparatus is configured to withstand a relatively high axial tension load allowing it to be incorporated into the main tensile load path of the elongate member.

According to a first aspect of the present invention there is provided apparatus for resisting bending of an elongate and flexible member, comprising:
an elongate inner support structure defining an axial bore for receiving an elongate and flexible member subject to bending in use; and
at least one outer layer comprising a plurality of fibres embedded in a polymer matrix, wherein each fibre is helically arranged along the outer layer and configured to resist a tensile force during said bending in use.

Optionally, the inner support structure comprises a plurality of coaxially arranged annular portions.

Optionally, the inner support structure comprises a closed-pitch tension helical spring.

Optionally, the at least one outer layer comprises a first fibre layer including a plurality of first fibres embedded therein and helically arranged in a first direction, and a second fibre layer including a plurality of second fibres embedded therein and helically arranged in a second direction opposed to the first direction.

Optionally, the second fibre layer is disposed on the first fibre layer.

Optionally, a number of fibres in the first fibre layer is less than a number of fibres in the second fibre layer.

Optionally, a third fibre layer disposed on the second fibre layer comprises a plurality of third fibres embedded therein and helically arranged in the first direction.

Optionally, a fourth fibre layer disposed on the third fibre layer comprises a plurality of fourth fibres embedded therein and helically arranged in the second direction.

Optionally, an inner protection layer is disposed between the at least one outer layer and the inner support structure.

Optionally, an outer protection layer is disposed on the at least one outer layer.

Optionally, the inner protection layer and/or the outer protection layer comprises neoprene.

Optionally, each of said fibres comprises polyester.

Optionally, the at least one outer layer comprises a rubber material in which the at least one fibre is embedded.

Optionally, the apparatus comprises first and second end fittings fixed to corresponding end regions of the inner support structure and the at least one outer layer.

Optionally, each end fitting comprises an axial through bore to allow the apparatus to be slidably located over the elongate and flexible member.

Optionally, each end fitting comprises attachment means for attaching the end fitting to the elongate and flexible member and at least axially constraining the apparatus with respect to the elongate and flexible member.

According to a second aspect of the present invention there is provided an assembly comprising an elongate and flexible member subject to bending in use and apparatus according to the first aspect of the present invention.

Optionally, the assembly comprises at least a part of a seismic streamer array.

Optionally, the part comprises a vibration isolation module assembly.

According to a third aspect of the present invention there is provided a method of manufacturing apparatus for resisting bending of an elongate and flexible member, comprising:
disposing at least one outer layer around an elongate inner support structure defining an axial bore for receiving an elongate and flexible member subject to bending in use, wherein the at least one outer layer comprises a plurality of helically arranged fibres embedded in a polymer matrix of the outer layer and configured to resist a tensile force during said bending in use.

Optionally, the inner support structure comprises a closed-pitch tension helical spring.

Optionally, the at least one outer layer comprises a first fibre layer including a plurality of first fibres embedded therein and helically arranged in a first direction, and a second fibre layer including a plurality of second fibres embedded therein and helically arranged in a second direction opposed to the first direction.

Optionally, the method comprises disposing an inner protection layer between the at least one outer layer and the inner support structure.

Optionally, the method comprises disposing an outer protection layer on the at least one outer layer.

Optionally, the method comprises terminating each end region of the inner support structure and the at least one outer layer in an end fitting.

### DESCRIPTION OF THE DRAWINGS

Certain embodiments of the present invention will now be described with reference to the accompanying drawings in which:

FIG. 1a illustrates a cross-sectional side view of a bend resistor according to certain embodiments of the present invention;

FIG. 1b illustrates region A of the side view of FIG. 1a;

FIG. 2a illustrates a cutaway side view of the bend resistor of FIG. 1a in a straight and unloaded state;

FIG. 2b illustrates a cross sectional view through the bend resistor of FIG. 2a;

FIG. 3 illustrates the internal spring and a fibre of a first fibre layer of the outer jacket of the apparatus of FIGS. 2a and 2b;

FIG. 4a illustrates a seismic streamer assembly comprising apparatus according to certain embodiments of the present invention;

FIG. 4b illustrates a mini-streamer of the seismic streamer assembly of FIG. 4a connected to the main body of the seismic streamer assembly;

FIG. 5 illustrates a longitudinal cross section through a portion of the apparatus according to an embodiment of the present invention;

FIG. 6 illustrates the transverse cross section B-B as referenced in FIG. 5;

FIG. 7 illustrates the section A as referenced in FIG. 6; and

FIG. 8 illustrates further properties of the fibre layers of the apparatus of FIGS. 5 to 7.

### DETAILED DESCRIPTION

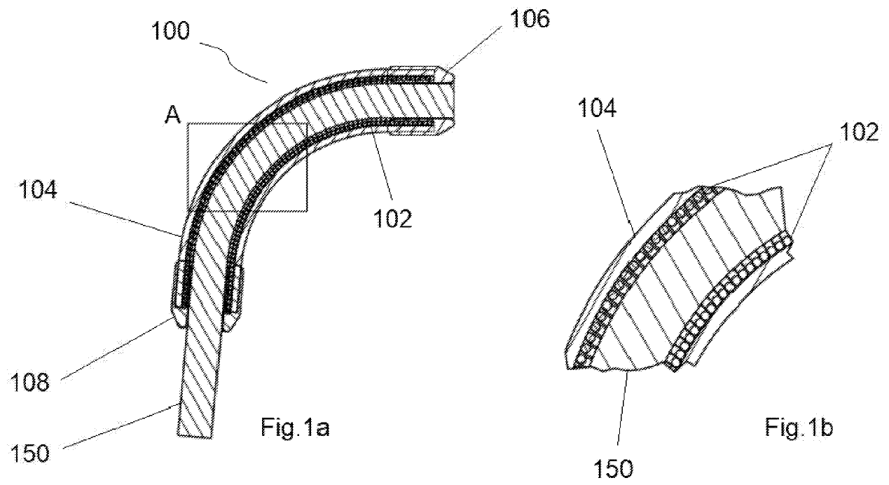

As illustrated in FIGS. 1a and 1b, apparatus 100 according to certain embodiments of the present invention for resisting bending of an elongate and flexible member 150, such as a marine cable, includes an inner support structure 102 and an outer jacket 104 located between opposed end fittings 106,108.

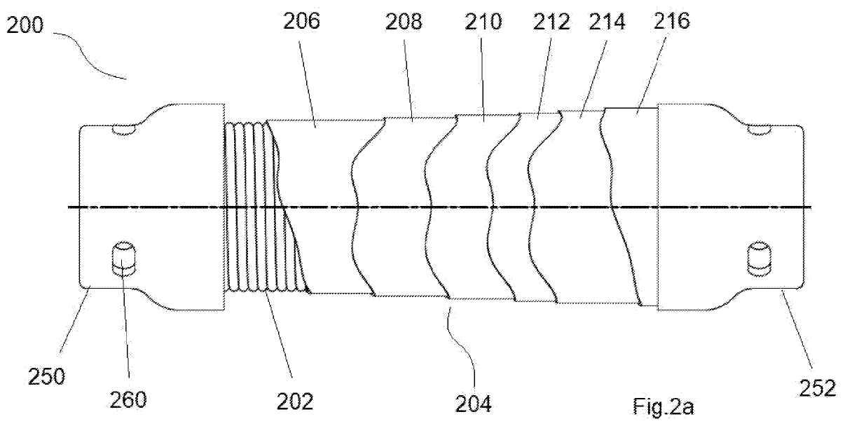

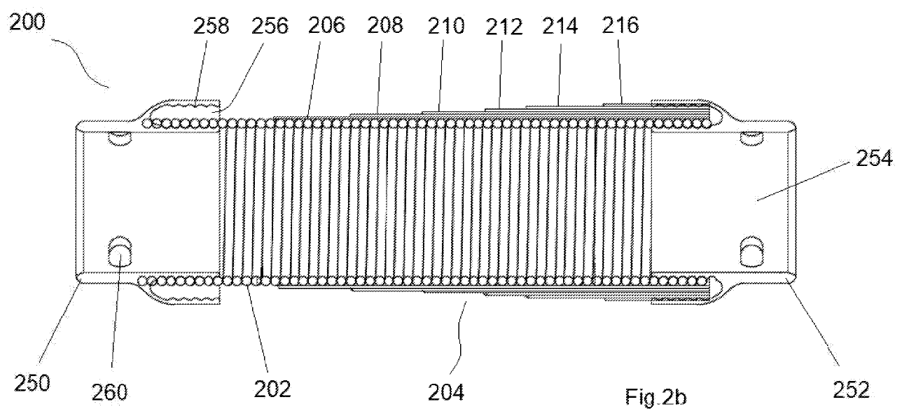

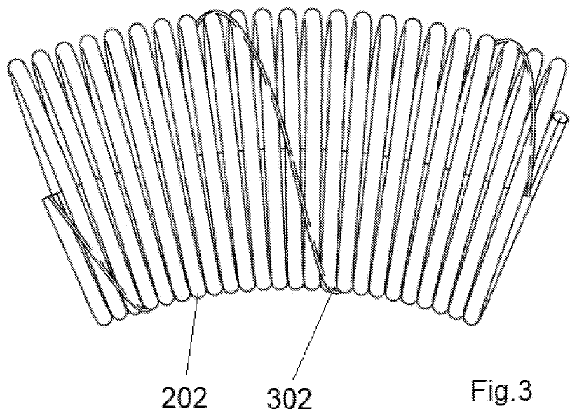

The inner support structure 102 comprises a helical spring which is in a closed pitch state when no bending load is applied to the flexible member 150 and in turn the apparatus 100, i.e. when a longitudinal axis of the apparatus is substantially linear, as illustrated in FIGS. 2a and 2b. The spring defines an axial through bore for receiving and locating the elongate member 150. Alternatively, the inner support structure 102 may comprise a plurality of coaxially arranged rings which abut each other when no bending load is applied to the apparatus. Aptly, the inner support structure 102 is a metal material, such as stainless steel to prevent corrosion if the apparatus is to be used in a marine or subsea environment. The inner support structure 102 is collapse-resistant to thereby support the outer jacket 104 whilst also protecting the flexible member 150 around which the apparatus 100 is located.

The outer jacket 104 comprises at least one layer of rubber or polymer material, such as styrene-butadiene rubber (SBR), and a plurality of fibres embedded therein. Aptly, each fibre is a polyester fibre which is helically arranged along the length of the outer jacket.

A detailed embodiment of the apparatus according certain embodiments of the present invention is illustrated in FIGS. 2a and 2b. The apparatus 200 includes a closed-pitch tension helical spring 202 and an outer jacket 204 comprising a plurality of layers. The spring and outer jacket terminate at each end in opposed end fittings 250,252. Each end fitting defines an axial bore 254 for allowing a flexible member, such as a cable or pipe, to be fed through the apparatus or the apparatus to be located on the flexible member, i.e. whichever is moveable in use and dependent on the technical application. Each end fitting also includes an annular recess 256 located outboard of the axial bore 254 which is configured to receive a respective end region of the spring and jacket layers. The end regions of the spring and jacket layers are then securely fixed to the respective end fitting by axially forcing the end fitting on to the respective end of the spring and jacket layers such that a gripping surface 258 provided in the annular recess 256 grips the spring and/or jacket layers and axially and rotationally constrains the same with respect to the respective end fitting. The gripping surface 258 may comprise a plurality of projections, such as axially spaced apart annular ribs or barbed regions. Alternatively, depending on the size, material and/or intended application of the apparatus, the spring and jacket layers may be secured to each end fitting by other suitable means, such as crimping, bolts or screws, bonding, interference fitting, compression fitting, or the like. Aptly, each end fitting is a metal material, such as marine grade stainless steel or the like.

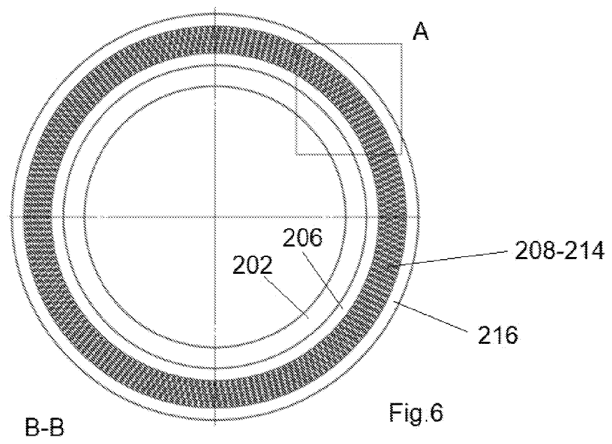

As illustrated in FIGS. 2a and 6, the outer jacket 204 of the apparatus 200 comprises six separate layers; an inner protection layer 206, a first fibre layer 208, a second fibre layer 210, a third fibre layer 212, a fourth fibre layer 214, and an outer protection layer 216. Aptly, the inner and outer protection layers 206,216 are neoprene rubber. Alternatively, the inner and outer protection layers may comprise another relatively soft yet tough polymer material such as polyurethane or the like. The inner protection layer 206 protects the fibre layers from the spring, particularly the first fibre layer 208 and particularly during repetitive bending cycles which could otherwise abrade and compromise the integrity of the fibre layer over time. The outer protection layer 216 protects the fibre layers, particularly the fourth fibre layer, from the external environment, such as temperature effects, UV degradation, impact/abrasion with objects and structures, etc.

Each fibre layer 208,210,212,214 comprises a plurality of polyester fibres helically arranged within a styrene-butadiene rubber (SBR) matrix. Alternatively, each fibre layer may comprise a different polymer material such as polyurethane or the like. The fibres in the first and third fibre layers 208,212 are helically arranged in the same direction, such as a right hand lay, and the fibres in the second and fourth fibre layers 210,214 are helically arranged in the opposite direction, such as a left hand lay. The aggregate of the tangential forces in the fibres of a first one of the fibre layers will generate a torque when subjected to strain. The fibres in a second one of the fibre layers adjacent to the first layer are arranged in the opposite direction to the fibres in the adjacent layer and will generate an opposing torque which will substantially cancel out the torque of the first layer. The number of fibre layers is therefore preferably even such that the net torque is zero or at least relatively low. During the design stage, the net torque of the apparatus may be calculated and the fibre angles of each fibre layer may be adjusted accordingly such that the net torque of the apparatus is zero or at least reduced. Opposing torques of adjacent fibre layers may also manifest themselves as shear stresses between the layers. It may therefore be preferred to provide a higher number of fibre layers each generating a relatively low torque so as to limit the shear stress and guard against potential delamination between the layers. Furthermore, depending on the design requirements, more or less layers may be provided depending on the desired stiffness of the assembly.

Additionally, or alternatively, the fibres in each fibre layer may terminate within the respective layers at different locations along the apparatus to provide a higher bending stiffness proximal one end of the apparatus compared to a lower bending stiffness proximal the other end of the apparatus. For example, the apparatus may have four fibre layers wherein the fibres of the innermost (first) fibre layer may terminate at around 50% along the length of the apparatus, the fibres of the second fibre layer may terminate at around 70% along the length of the apparatus, the fibres of the third fibre layer may terminate at around 90% along the length of the apparatus, and the fibres of the fourth fibre layer may extend the entire length of the apparatus. This arrangement may desirably create a higher bending stiffness proximal a first end region of the apparatus wherein all the fibre layers have fibres extending therealong and therearound, and wherein the bending stiffness gradually decreases towards the second end region of the apparatus wherein only the fourth fibre layer has fibres extending therealong and therearound. Alternatively, the fibres of one or more fibre layers may terminate at both ends of the fibres between the end regions of their respective fibre layers such that the bending stiffness in one portion, such as a central portion, along the apparatus is greater than the bending stiffness of another portion or portions, such as one or both end portions, along the apparatus.

Further additionally, or alternatively, the number of fibres in each fibre layer may be different, e.g. the number of fibres in an innermost fibre layer may be less than the number of fibres in an outermost fibre layer. For example, for an apparatus including four fibre layers, the innermost fibre layer may comprise 163 fibres, the second fibre layer may comprise 170 fibres, the third fibre layer may comprise 177 fibres, and the outermost fibre layer may comprise 184 fibres. This may be desirable in view of the fibre spacing in each layer being constant but the mean diameter of each fibre layer increasing as one moves outwardly through the fibre layers.

Aptly, each fibre layer is around 1.6 mm thick and the polyester fibres embedded therein have a diameter of around 0.8 mm and are spaced apart by around 0.83 mm. Each fibre has a tensile break load of around 33 kg and an elongation at break of around 12%. The fibre angle is around 54.7 but the fibre angle may be greater or less than that depending on the requirements and application of the apparatus. Likewise, the other properties of the fibres may be different depending on the requirements and application of the apparatus. Further alternatively, the material of the fibres may not be a polymer material, such as stainless steel, and the other properties of the fibres and the other layers of the apparatus may be determined accordingly depending on the requirements and application of the apparatus.

For illustration purposes, a single fibre 302 of the first fibre layer 208 is shown in FIG. 3. The fibre 302 is helically arranged along and within the SBR matrix (not shown) in the same direction as the inner support structure 202 which is in the form of a closed-pitch tension helical spring. Alternatively, the fibre of the first fibre layer may be helically arranged in an opposite direction to the spring coils or, as described above, the inner support structure may comprise a plurality of coaxially arranged rings which do not define a helix and therefore have no helical direction. The diameter/thickness of the coiled wire is greater than the diameter/thickness of the fibre. The pitch of the spring is determined by the spring wire diameter. The spring wire diameter is determined by the anticipated radial force generated by the strained fibres in the jacket. The spring wire diameter has to be large enough to prevent collapse. The radial force is a function of layer diameter, layer thickness, fibre size, fibre stiffness, fibre pitch, fibre angle and the radius of the bend aggregated for the whole assembly. As an example, a spring having an outer diameter of around 73 mm may have a thickness of around 5 mm and a pitch of around 5 mm when in a closed, unstressed state, and the fibre may have a thickness of around 0.8 mm.

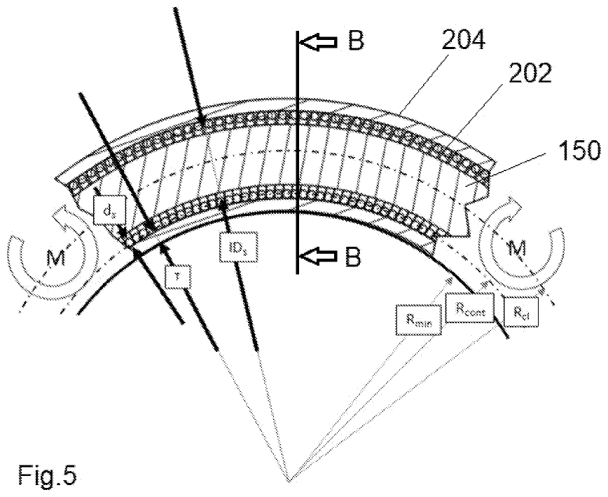

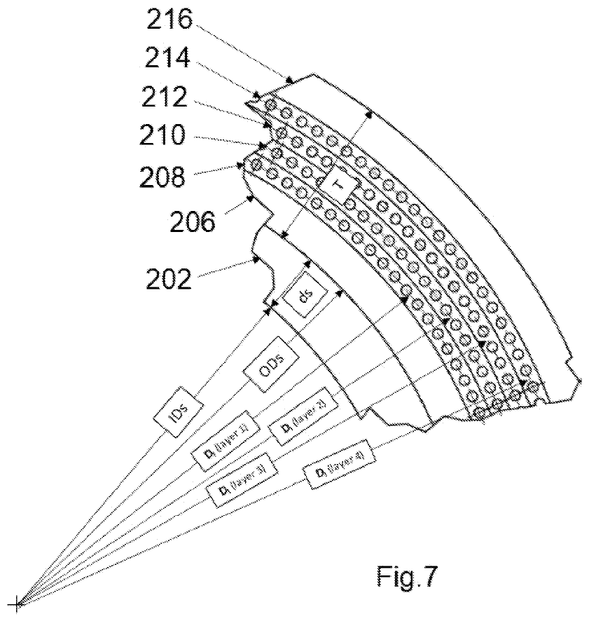

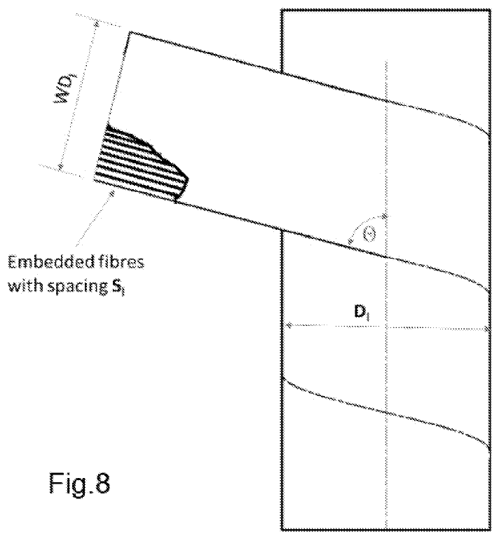

A method of determining the design parameters of the apparatus according to certain embodiments of the present invention is outlined below with reference to FIGS. 5 to 8. For this example, the following information relating to the intended application for the apparatus is assumed to be known:
Bend stiffener minimum bore;
Bend stiffener minimum bend radius Rₘᵢₙ for a target bending moment M; and
Physical interface requirements.
1. Set ID (IDₛ) of Spring based on required bore of the assembly;
2. Choose wire size of spring (dₛ)—start with a practical estimate 8%-10% of IDₛ;
3. Calculate pitch of spring (p). p=dₛ to achieve a closed pitch spring;
4. Calculate outer diameter of Spring (ODₛ). ODₛ=IDₛ+2*dₛ;
5. Assume a jacket construction, e.g. 3 mm neoprene inner layer, four fibre layers, 3 mm neoprene outer layer, total thickness (T)=3+4*1.6+3=12.4 mm;
6. Assume a fibre type and density of fibres, e.g:
   Layer matrix material SBR
   Layer thickness is 1.6 mm
   Fibre is Polyester
   Fibre max Strain (E_{f}) at break 13%
   Fibre max load (F_{f}) at break 33 Kg
   Fibre spacing in the layer 1.8 mm
7. Calculate Jacket Total thickness (T) based on the above construction, e.g. T=3+4*1.6+4=12.4 mm;
8. Determine the radius of the spring coil contact points on the inside of the curve (R_{cont})=Rₘᵢₙ+T+dₛ/2;
9. Determine the radius of the centre line of the bend stiffener assembly R_{cl}=Rₘᵢₙ+T+dₛ+IDₛ/2;
10. Calculate average strain along the centre line (e_{cl}) of the assembly when bent over design radius. e_{cl}=(dₛ/2+IDₛ/2)/(Rₘᵢₙ+T+dₛ/2);
11. For each layer with fibre laid at an angle of Q from the centre line, calculate the strain in the fibres (e_{f}). e_{f}=e_{cl}/cos Q;
12. Calculate the mean cross sectional diameter Dₗ for the layer based on the assumed construction;
13. Calculate the circumference of the mean diameter of the layer CDₗ=pi*Dₗ;
14. Calculate the width of the fibre strip required to make the layer helical wrap with no overlap (WDₗ)=CDₗ*cos Q;
15. Calculate the number of fibres in the layer (n) by dividing the width of the strip by the fibre spacing S_{f}. n=WDₗ/Sₗ;
16. Based on the known max load and elongation of the fibre, and the fibre strain, calculate the individual fibre load (f_{f}). f_{f}=e_{f}*100*F_{f}/E_{f};
17. Based on the Fibre load and the fibre angle, calculate the axial load for each fibre (f_{fa}). f_{fa}=f_{f}*cos Q;
18. For each Layer, calculate the total axial fibre load (f_{Tfa})=f_{Tfa}=N*f_{fa};
19. For each layer calculate the bending moment (Mₗ). Mₗ=f_{Tfa}*(d/2+IDs/2);
20. Calculate the total bending moment (M_{T}). M_{T}=Sum of the bending moment Mₗ for all layers;
21. Compare total bending moment with the given target bending moment then iterate to optimise design by changing one or more of the variables, most commonly the number of layers, angle of fibres, fibre spacing, or diameter of fibres;
22. When the target bending moment has been reached, it is necessary to check the following design limits:
   i. Fibre strain in any fibre is less than around 25% of the ultimate fibre strain; and
   ii. Spring hoop stress is less than around 25% of the spring wire material yield stress.

When the apparatus is caused to bend in use, the internal spring coils 202 remain closed on the inner side of the bend and gaps form on the outer side of the bend, the gaps being in proportion to the bend radius. The spring coils 202 remain substantially round, i.e. the inner diameter of the spring remains substantially round, to protect the flexible member therein and to prevent the outer jacket 204 from collapsing. Under such conditions, the length of the fibre/s 302 in each fibre layer increases which induces strain and therefore tension in the fibres. The tensile force in the fibres is a function of the amount of strain and the fibre stiffness. In view of the fibres being helically wound, the fibre force will have an axial and a tangential component relative to the spring. The aggregated tangential force from all the fibres results in a hoop force that is reacted by the radial stiffness of the spring and manifests itself as a compressive stress in the spring coils. For each fibre, the axial force component multiplied by the distance from the spring coil contact points produces a bending moment. The aggregate of these bending moments for all the fibres in all the fibre layers will be equal to the overall bending moment being applied to the apparatus.

The fact that the fibres are helically wound and travel the length of the outer jacket and the jacket material being substantially compliant means that the load tends to be evenly distributed and the bending radius is substantially maintained over the length rather than being concentrated at the point where the unit is connected to the stiffer structure, such as a coupling or a bulkhead.

The neoprene material of the protection layers, the SBR matrix material of the fibre layers, and the spring may offer some resistance to bending but this is only a relatively minor component of the total bend resistance provided by the apparatus and is relatively insignificant compared to the bend resistance offered by the fibres in the fibre layers of the outer jacket.

The apparatus according to certain embodiments of the present invention may be used for a number of different marine applications to support flexible pipe, umbilicals and cables when connected to rigid structures or a floating production system where there is a requirement to control the minimum bend radius of the pipe. The apparatus may be integrated into a cable construction and thus the end fittings described above may not be required. Another suitable application is in seismic streamers which comprise an array of hydrophones and electronic circuits contained in a flexible hose which is towed behind a vessel from which the streamers are put out into the sea to carry out seismic surveys of the seabed and/or subsurface formations. Echoes received by the hydrophones get relayed to the vessel via cables. It is customary to attach a long tail rope to the rear of the array for stability during towing. A known problem of streamer arrays is noise created by axial vibration and turbulent boundary layer effects which degrades the performance of the streamer. In an attempt to address this problem, it is known to locate vibration isolation modules between the head of the streamer array and the towing cable and between the tail of the streamer array and the tail rope.

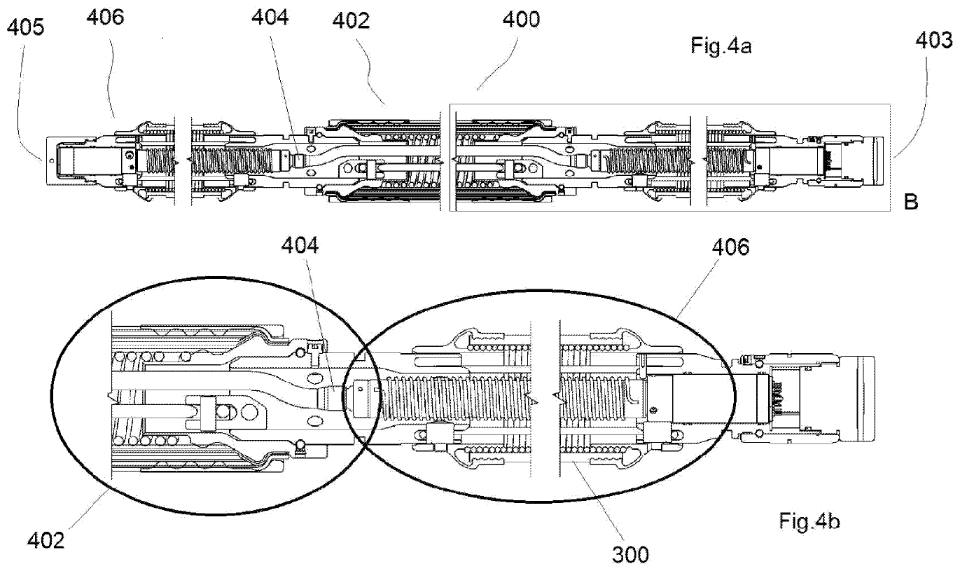

A known isolation module assembly 400 is the Phoenix Vibration Isolation Module (PVIM) by Pheonix Engineering Limited which, as illustrated in FIG. 4a, comprises a main body 402 housing an optical/electrical harness 404 extending therethrough. The assembly has a head end region 403 and a tail end region 405. The main body 402 of the PVIM assembly 400 ranges from 1 m to 9 m and provides acoustic attenuation at specific frequencies. The ends of the main body 402 are very stiff due to the size of the mechanical termination parts of the outer jacket and this can generate large bending moments when the assembly is recovered onto or deployed off a winch drum. As illustrated in FIG. 4a, the PVIM assembly 400 includes ‘mini-streamers’ 406 connected to each end of the main body 402 to provide some flexibility at the ends thereby reducing such bending moments. Standard mini-streamer jackets offer no bend restriction and have a very low radial stiffness. As a result, the head and tail ends of the PVIM assembly 400 and the optical/electrical harness inside each mini-streamer 406 can be exposed to very tight bend radii and physical impingement by other equipment during deployment and recovery, being involved in a tangle or, as a result of poor packing during transport. In such situations, the optical/electrical fibres can be damaged and fail. The apparatus 300 according to certain embodiments of the present invention may be incorporated into the/each mini-streamer 406 as illustrated in FIG. 4b to provide protection against tight radii by offering substantially increased bending stiffness and also to provide improved protection against impingement by, for example, other equipment during deployment and recovery in view of the internal spring surrounding the mini-streamer. The apparatus 300 is attached to the/each mini-streamer by bolting the end fittings of the apparatus to the mini-streamer body via the slotted through holes 260 in each end fitting as illustrated in FIGS. 2a and 2b. The slots and bolts provide a relatively loose connection to axially and rotationally limit the apparatus with respect to the mini-streamer body, whilst radial movement is constrained by the annular arrangement of the apparatus on the mini-streamer body. A relatively loose connection also prevents the build-up of assembly stresses and eliminates the need for tight tolerances. Alternatively, other attachment means may be provided, such as clamping or locking, to at least axially constrain each end fitting with respect to the mini-streamer body. For example, an annular groove may be provided in an outer surface of the mini-streamer body and one or more locking elements may be provided on each end fitting to be selectively moveable into the groove to axially lock the end fitting to the mini-streamer body whilst allowing for some rotational movement in use. If rotational movement of the apparatus is not desired, one or more recesses may be provided in the outer surface of the mini-streamer body for a corresponding locking element, such as a pin or bolt, to engage in when in a locked position.

Certain embodiments of the present invention therefore provide apparatus to resist bending of an elongate member, such as a pipe, hose or electrical cable, and thereby restrict or limit the amount of bending to prevent failure of the elongate member. The apparatus is configured to resist bending of the elongate member wherein the bending load is substantially evenly distributed through the apparatus and the bend radius is substantially maintained over the length of the apparatus.

The apparatus according to certain embodiments of the present invention can offer a number of technical advantages over conventional bend stiffeners and these advantages can be optimised by controlling the various design parameters of the apparatus, such as diameter, length, spring wire size, number of fibre layers, and/or number and orientation of fibres as well as the materials chosen for all of these components. The apparatus can be designed to have a higher bending stiffness than an equivalently-sized conventional bend stiffener through manipulation of the basic design parameters. This is due to the relatively high stiffness and strength of the polyester fibres when nested in a rubber matrix as compared to a homogeneous polyurethane structure as found in conventional bend stiffeners. The structure of the apparatus is extremely robust compared to conventional bend restrictors or bend stiffeners due to the use of the highly abrasion-resistant outer neoprene layer combined with the particularly high radial strength of the internal spring. This results in an assembly that would prove to be rugged in the most aggressive environments and protect against crushing or penetration by external bodies, particularly in marine or subsea applications such as cables, pipes, and hoses. The apparatus is capable of sustaining a particularly high axial load and so can be integrated into the main tensile load path of the flexible member, such as a seismic streamer assembly. If bend restriction and axial load capability were simultaneously required, this can be achieved by building the assembly with a pre-load in the outer jacket such that the spring remains closed pitch at all loads up to the pre-tension load.

1. Apparatus for resisting bending of an elongate and flexible member, comprising:
an elongate inner support structure defining an axial bore for receiving an elongate and flexible member subject to bending in use; and
at least one outer layer comprising a plurality of fibres embedded in a polymer matrix, wherein each fibre is helically arranged along the outer layer and configured to resist a tensile force during said bending in use.

2. The apparatus according to claim 1, wherein the inner support structure comprises a plurality of coaxially arranged annular portions.

3. The apparatus according to claim 2, wherein the inner support structure comprises a closed-pitch tension helical spring.

4. The apparatus according to claim 1, wherein the at least one outer layer comprises a first fibre layer including a plurality of first fibres embedded therein and helically arranged in a first direction, and a second fibre layer including a plurality of second fibres embedded therein and helically arranged in a second direction opposed to the first direction.

5. The apparatus according to claim 4, wherein the second fibre layer is disposed on the first fibre layer.

6. The apparatus according to claim 5, wherein a number of fibres in the first fibre layer is less than a number of fibres in the second fibre layer.

7. The apparatus according to claim 4, wherein a third fibre layer disposed on the second fibre layer comprises a plurality of third fibres embedded therein and helically arranged in the first direction.

8. The apparatus according to claim 7, wherein a fourth fibre layer disposed on the third fibre layer comprises a plurality of fourth fibres embedded therein and helically arranged in the second direction.

9. The apparatus according to claim 1, wherein an inner protection layer is disposed between the at least one outer layer and the inner support structure.

10. The apparatus according to claim 1, wherein an outer protection layer is disposed on the at least one outer layer.

11. The apparatus according to claim 9, wherein the inner protection layer and/or the outer protection layer comprises neoprene.

12. The apparatus according to claim 1, wherein each of said fibres comprises polyester.

13. The apparatus according to claim 1, wherein the at least one outer layer comprises a rubber material in which the at least one fibre is embedded.

14. The apparatus according to claim 1, comprising first and second end fittings fixed to corresponding end regions of the inner support structure and the at least one outer layer.

15. The apparatus according to claim 14, wherein each end fitting comprises an axial through bore to allow the apparatus to be slidably located over the elongate and flexible member.

16. The apparatus according to claim 15, wherein each end fitting comprises attachment means for attaching the end fitting to the elongate and flexible member and at least axially constraining the apparatus with respect to the elongate and flexible member.

17. An assembly comprising an elongate and flexible member subject to bending in use and apparatus according to claim 1.

18. The assembly according to claim 17, comprising at least a part of a seismic streamer array.

19. The assembly according to claim 18, wherein the part comprises a vibration isolation module assembly.

20. A method of manufacturing apparatus for resisting bending of an elongate and flexible member, comprising:
disposing at least one outer layer around an elongate inner support structure defining an axial bore for receiving an elongate and flexible member subject to bending in use, wherein the at least one outer layer comprises a plurality of helically arranged fibres embedded in a polymer matrix of the outer layer and configured to resist a tensile force during said bending in use.

21-25. (canceled)
